(19) United States
(12) Patent Application Publication
(10) Pub. No.: US 2018/0238084 A1
(43) Pub. Date: Aug. 23, 2018

(54) Lever Gate Latch Pull System and Kit

(71) Applicant: Karen H. Weber, Woodinville, WA (US)

(72) Inventor: Karen H. Weber, Woodinville, WA (US)

(21) Appl. No.: 15/690,465

(22) Filed: Aug. 30, 2017

Related U.S. Application Data
(60) Provisional application No. 62/462,437, filed on Feb. 23, 2017.

(51) Int. Cl. E05C 3/16; E05C 3/00

(52) U.S. Cl. CPC E05C 3/165; E06B 11/02; E05C 3/006

(57) ABSTRACT

A lever gate latch pull system with a pivoting Z shaped lever having a bent first arm with lever handle pivotally affixed to a fence post to pivot up and down. Opposite the first lever arm is a pivoting bent second arm affixed to a chain extending to and secured via a fastener to a gate latch pivotal latch lever. When the lever handle first arm is depressed, the second lever arm elevates to pull the chain up to unlatch the gate latch to open the gate. The lever handle is positioned usually just beneath the top of the fence, allowing a user to depress it from both sides of the latched gate to raise the chain to unlatch the gate latch; thereby enabling one to unlatch a locked gate without having to go around to unlatch the gate.

### RELATED APPLICATIONS

This application claims the benefit of U.S. provisional patent application entitled “Lever Gate Latch Pull System and Kit”, Ser. No. 62/462,437 filed Feb. 23, 2017.

### BACKGROUND OF THE INVENTION

### Field

This invention pertains to gate latch pull systems. More particularly it relates to a lever gate latch pull system and kit of simple construction readily mounted on a gate post.

### Statement of the Art

There are a number of latching systems. Casey, U.S. Pat. No. 5,655,801 issued Aug. 12, 1997 discloses a gate latch with a bent lever arm assembly passing through a gate with linkage associated with the gate latch for opening it from the outside.

Glover, U.S. Pat. No. 9,297,187 issued Mar. 29, 2016 is another gate latch release mechanism with a cylindrical tubular guide positioned in a hole through a gate post with a flexible line affixed to the latch handle for opening the gate latch from outside. This flexible line can kink or bind when drawn through the tubular guide in the fence post.

Van Wieb, U.S. Pat. No. 5,358,292 issued Oct. 25, 1994 is a gate latch pull system secured to a stationary gate post pulled from outside the gate secured to the gate latch to open it from the outside. It also employs a flexible cable with coiled spring, which can kink or bind when drawn through a bore hole in the gate post, when pulled from the outside.

Bieganski, U.S. Pat. No. 5,078,438 issued Jan. 7, 1992 is another gate closure latch using a pull ring string passing through the gate post tied to the gate assembly for opening it from the outside. It is secured to the ends of a pair of hand grips.

Thomas, U.S. Pat. No. 4,938,508 issued Jul. 3, 1990 is a gate latch with a pull mechanism to allow the gate latch to be unlatched when pulled. It incorporates a spring biased plunger preventing the pivotal latch member from being unlatched by the wind.

Cited for general interest are:

Wepf, U.S. Pat. No. 9,528,306 issued Dec. 27, 2016 is a locking latch for yard doors with a lock base and lock cover openable/closable in a clamshell mode.

Nesseth, U.S. Publication No. 2006/0038416 published Feb. 23, 2006 is a ranch gate assembly for swinging latch gates operable by a horse.

Eblen, U.S. Pat. No. 3,828,475 issue Aug. 13, 1974 is another gate opener for a tractor driven against the gate, which causes the gate to swing open for driving there through. Once the tractor has disengaged, the gate closes via a spring system.

As discussed in Van Wiebe, the present invention is directed to a conventional form of gate latch employed in connection with a stationary gate post amounted adjacent the free edge of a hinged gate. The gate is typically secured to an additional stationary fence post by hinges. A latch bar mounting plate is secured to the gate via conventional fasteners. The latch bar typically includes a right angle bend portion such that the latch bar is disposed in alignment for engagement in a latch bracket secured to the stationary gate post. Alternatively, the bracket may be secured to the gate and the latch bar mounted on the post without altering the function of the components.

The pivotal latch lever includes a recess which partially surrounds the latch bar in the latch position as shown in FIG. 1 prior art. An outermost free end portion of the pivotal latch lever is provided with an aperture through which a string or cord extends. A first end of the string or cord is received through a staple driven into the top end face of the gate post. The first end of the string is secured by a knot or loop to an enlarged ring. A second opposite end of the string or cord is secured by a loop or knot fastener to a second enlarged ring. Thus it is contemplated by pulling on one or both of the rings that the pivotal latch lever may be moved to an unlatch position us a user position on the opposite side of the gate. As this remote latch actuating mechanism does not provide constant downward pressure on the latch lever, it doesn't stop the latch bar from bouncing out when the gate is closed or slammed. Thus upon release of the rings only gravity causes the pivotal latch lever to move to the latched position. There is thus a substantial chance that due to frictional forced in the pivotal mounting of the latch lever or friction of the string and the staple or bore, or the opposing counterweight forced exerted by the rings that the pivotal latch lever will not move to a fully latched position.

There thus remains a need for a simple lever gate latch pull system and kit of straight forward construction readily mounted on a gate post, which insures that the latch lever prevents the latch bar from bouncing out. The apparatus described below provides such an invention.

### SUMMARY OF THE INVENTION

The present invention comprises a lever gate latch pull system for a swinging gate having a gate latch affixed to a fence post with an openable lifting keeper. A latch adapted to be affixed to an edge of a swinging gate edge is positioned and aligned with the keeper to latch and unlatch to open or close the swinging gate. A pivoting Z shaped lever having a center section with a center pivot and opposite first and second ends has a center pivot structured to affix to the fence post to pivot the first and second ends up and down. A first arm is attached normal the center section first end and structured as a lever handle. A second arm is attached to the second end of the center section aligned pointing in the opposite direction of the first end, and having an attachment end. The first arm, when the Z shaped lever is pivotally attached, thus points toward the fence, and the second arm points in the opposite direction away from the fence.

A weighted chain with a first chain end is affixed to the second arm attachment end. The second chain end is affixed to the pivotal latch. The length of the chain is sized and weighted to hang and provide pressure on the pivotal latch to stay in a latched position until raised. When the Z shaped lever is activated to lift the second end of the chain to lift and open the keeper, the latch is to open the gate latch.

The center pivot may be structured as a pivot hole, through which a fastener extends through with one end structured to secure to the fence post, and the other end is flanged larger than the pivot hole to prevent the pivoting Z shaped lever from removal as the Z shaped lever is moved up and down.

Usually, the lever handle is positioned just below the top of the fence so that it is invisible from the outside, but allows a user to depress it from both sides of the latched gate to raise the chain to unlatch the gate latch. However, in other fence designs not built to have the fencing rise above the cross board, the lever and handle may be visible.

In operation, when the lever handle first arm handle is depressed, the second arm elevates to pull the chain up to unlatch the gate latch to open the gate.

The invention may be adapted as a kit to modify an existing gate latch pull system to be opened from either side. The lever gate latch pull system kit is for a swinging gate having a gate latch affixed to a fence post with an openable lifting keeper, and a latch affixed to an edge of the swinging gate edge positioned and aligned with the keeper to latch and unlatch to open or close the swinging gate. It comprises a pivoting Z shaped lever having a center section with a center pivot and opposite first and second ends. The center pivot is structured to affix to the fence post in a manner to pivot the first and second ends up and down. A first arm is attached normal the center section first end of the Z shaped lever and structured as a lever handle. A second arm is attached to the second end of the center section of the Z shaped lever aligned pointing in the opposite direction of the first end, and has an attachment end.

A weighted chain with a first chain end is affixed to the second arm attachment end. The chain second chain end has a fastener structured to affix to the keeper. The chain is of a length to hang and provide pressure on the keeper to stay in a latched position until raised up to lift and open the keeper to release the latch as the lever handle is activated to lift the chain to open the gate latch.

In another embodiment, the first chain end is not affixed to the second arm attachment end, and includes a fastener to affix to the second arm attachment end.

The kit thus comprises a Z shaped lever arm with a first arm with lever handle and a pivot hole structured to be pivotally affixed to a fence post to pivot up and down, and a bent second arm pointing opposite the first arm. A weighted chain is included with one end adapted to be affixed to the second arm and having a fastener attached to its other end structured to secure to the gate latch keeper in a manner to open and close it; thereby opening the gate latch. The Z shaped lever arm is preferable structured for positioning usually just beneath the top of the fence as discussed above.

### DESCRIPTION OF THE DRAWINGS

FIG. 1 illustrates a perspective view of the prior art of a conventional gate latch.

FIG. 2 illustrates a perspective view of the lever gate latch pull system in locked position.

FIG. 3 illustrates a side view of the lever gate latch pull system of FIG. 1.

FIG. 4 illustrates a perspective view of the lever arm of FIG. 1.

FIG. 5 illustrates a perspective view of the lever gate latch pull system of FIG. 4 secured to a fence post.

### DESCRIPTION OF THE ILLUSTRATED EMBODIMENTS

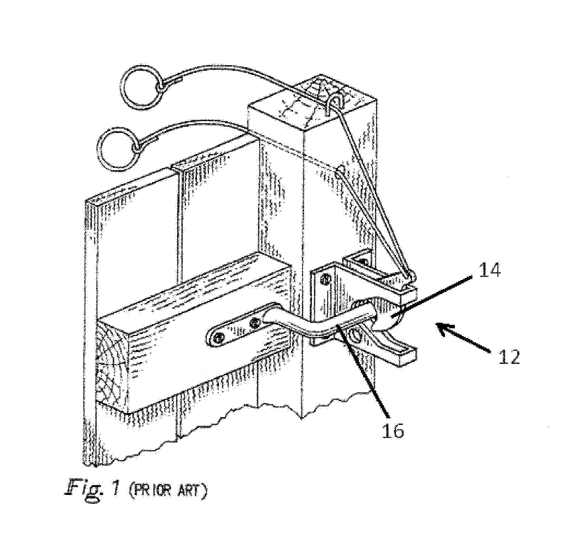

FIG. 1 illustrates a perspective view of the prior art of a conventional gate latch 12 with a keeper 14 secured to a fence post positioned and adapted to secure to a latch 16 affixed to a swinging gate.

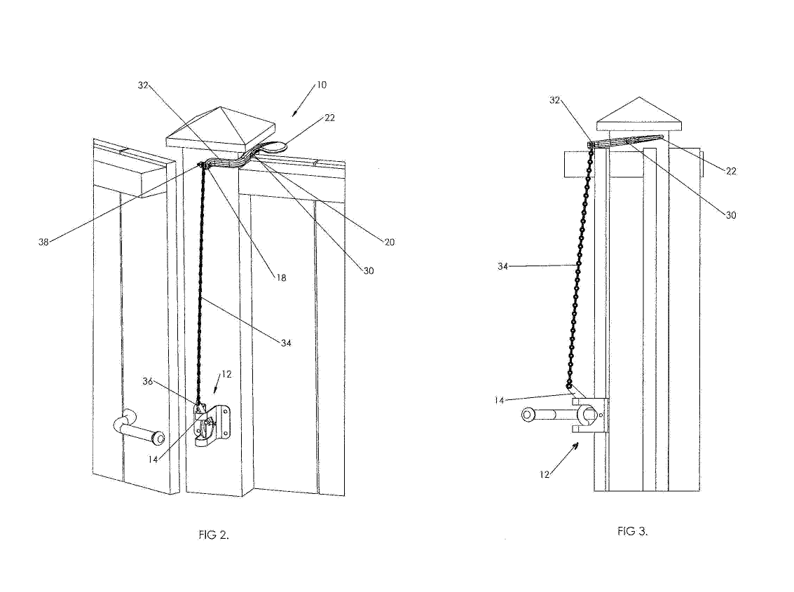

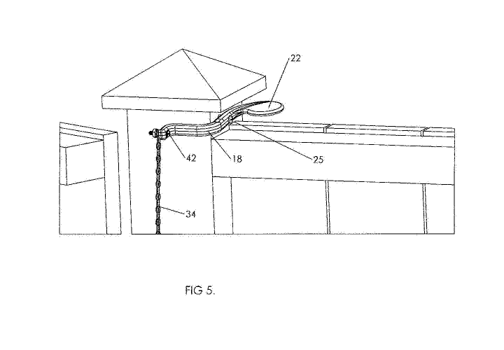

FIG. 2 illustrates a perspective view of the lever gate latch pull system 10 of the present invention in a locked position. It comprises a Z-shaped pivoting lever 18 with first lever arm 20 having a lever handle 22 pivotally affixed to a fence post via a wood screw 24 and washer 26 passing through a pivot 28 inserted in a pivot hole 30 as shown in FIG. 4 to pivot up and down. Opposite the first lever arm 20 is a pivoting second arm 32 affixed to a chain 34 extending to and secured via a fastener 36 to the keeper 28 of a gate latch 12 in the resting position. When the lever handle 22 first arm 20 is depressed, the second lever arm 32 lifts to pull the chain 34 up to unlatch the keeper 14 of the gate latch 12 to release the latch 16 to open the gate.

The Z-shaped pivoting lever 18 has opposite pointing arms 20, 32. A lever handle 22 is affixed to the bent arm 20 extending outwardly from a pivot hole 30. The opposite bent arm 32 extends inwardly from the pivot hole 30 with a chain attachment end 38 to which one end of a chain 34 is affixed. The Z-shaped pivoting lever 18 with pivot hole 30 is pivotably attached to a fence post usually as shown via a wood screw 24 with screw head 25 passing through the pivot insert 40 inserted in the pivot hole 30. The lever handle 22 is positioned usually near the top of the fence, allowing a user to depress it from both sides of a latched gate to raise the chain 34 to unlatch the keeper 14; thereby enabling one to unlatch a locked gate without having to go around to unlatch the gate.

The dimensions of one example of the Z-shaped pivoting lever 18 has a lever handle 22 of a length 2½ inches, a bent arm 20 of a length of 3½ inches, and a bent arm 32 of a length of 2½ inches.

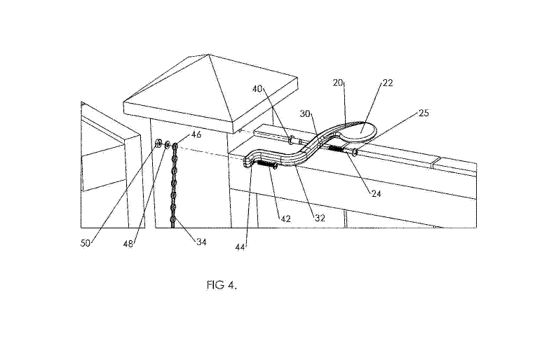

FIG. 3 is a side view of the lever gate latch pull system of FIG. 1.

FIG. 4 illustrates and exploded view of the Z-shaped pivoting lever 18 with opposite pointing arms 20, 32 of FIG. 2 and its components used to pivotally attach the lever gate latch pull system to a fence post as described above. To secure the Z-shaped pivoting lever 18 to the chain 34, a bolt 42 passes through a hole 44 and the end 46 of the chain 34 and is secured by a washer 48 and nut 50

FIG. 5 illustrates a perspective view of the lever gate latch pull system of FIG. 4 secured to a fence post.

Although a chain 22 is shown, other similarly weighted lines, cables, and ropes may be used, provided they are weather resistant and are structured, sized and weighted to hang and provide pressure on the pivotal latch to stay in a latched position until raised. They will all be referred to hereafter as chains 22.

The present invention may be embodied in other specific forms without departing from its structures, methods, or other essential characteristics as broadly described herein and claimed hereinafter. The described embodiments are to be considered in all respects only as illustrative, and not restrictive.

I claim:

1. A lever gate latch pull system for a swinging gate comprising:
(a) a gate latch affixed to a fence post with an openable lifting keeper,
(b) a latch affixed to an edge of a swinging gate edge positioned and aligned with the keeper to latch and unlatch to open or close the swinging gate,
(c) a pivoting Z shaped lever having:
i. a center section with a center pivot and opposite first and second ends, the center pivot structured to affix to the fence post to pivot the first and second ends up and down,
ii. a first arm attached normal the center section first end and structured as a lever handle,
iii. a second arm attached to the second end of the center section aligned pointing in the opposite direction of the first end, and having an attachment end, and
(d) a weighted chain with a first chain end affixed to the second arm attachment end and a second chain end affixed to the pivotal latch of a length to hang and provide pressure on the pivotal latch to stay in a latched position until raised up to lift and open the keeper to release the latch as the lever handle is activated to lift the chain to open the gate latch.

2. A lever gate latch pull system according to claim 1, wherein the center pivot is structured as a pivot hole, through which a fastener extends there through with one end structured to secure to the fence post, and the other end is flanged larger than the pivot hole to prevent the pivoting Z shaped lever from removal as the Z shaped lever is moved up and down.

3. A lever gate latch pull system according to claim 1, wherein the lever handle is positioned just below the top of the fence so that it is invisible from the outside, but allows a user to depress it from both sides of the latched gate to raise the chain to unlatch the gate latch.

4. A lever gate latch pull system kit for a swinging gate having a gate latch affixed to a fence post with an openable lifting keeper, and a latch affixed to an edge of the swinging gate edge positioned and aligned with the keeper to latch and unlatch to open or close the swinging gate, comprising:
(a) a pivoting Z shaped lever having:
iv. a center section with a center pivot and opposite first and second ends, the center pivot structured to affix to the fence post to pivot the first and second ends up and down,
v. a first arm attached normal the center section first end and structured as a lever handle,
vi. a second arm attached to the second end of the center section aligned pointing in the opposite direction of the first end, and having an attachment end, and
(b) a weighted chain with a first chain end affixed to the second arm attachment end and a second chain end with a fastener to affix to the pivotal latch of a length to hang and provide pressure on the keeper to stay in a latched position until raised up to lift and open the keeper to release the latch as the lever handle is activated to lift the chain to open the gate latch.

5. A lever gate latch pull system kit, according to claim 4, wherein the first chain end is not attached to the second arm attachment end, and includes a fastener to affix to the second arm attachment end.
